(19) United States
(12) Patent Application Publication
(10) Pub. No.: US 2016/0107332 A1
(43) Pub. Date: Apr. 21, 2016

(54) 3D PRINTING SYSTEM

(71) Applicant: Caterpillar Inc., Peoria, IL (US)

(72) Inventor: Tazio S. Grivetti, Chillicothe, IL (US)

(73) Assignee: Caterpillar Inc., Peoria, IL (US)

(21) Appl. No.: 14/979,608

(22) Filed: Dec. 28, 2015

(51) Int. Cl. B28B 1/00

(52) U.S. Cl. CPC B28B 1/001; B33Y 30/00

(57) ABSTRACT

A three dimensional printing system includes a cement source adapted to supply a material. A first extruder adapted to extrude material to form a first layer, and at least one second extruder adapted to extrude material to form at least one second layer over first layer. The first extruder and the at least one second extruder, being in fluid communication with the cement source, and adapted to receive material from the cement source. The first extruder and at least one second extruder placed in series configuration, and adapted to work in collaboration, such that the first extruder and at least one second extruder move simultaneously and at least one second layer is formed over first layer after a delay. The delay is proportional to a rate of motion of first extruder or at least one second extruder, rate of solidification of material, as-extruded surface tension, and inherent integrity of material.

### TECHNICAL FIELD

The present disclosure relates to a three dimensional printing system, and more specifically, to the three dimensional printing system with multiple extruders.

### BACKGROUND

3D printing is a molding technique for building 3D objects such as, but not limited, to model of homes, offices, objects etc. Generally, a 3D printer includes a printing head. In order to build the 3D objects, the printing head deposits layers of a material, one over another. Typically, the material used in making the 3D objects, is a range of plastic materials, polylactic acid, acrylonitrile butadiene styrene, polystyrene, polycarbonate, polyethylene terephthalate polymer, nylon, urethane, or other materials. These materials may be used in combination with other materials, such as ceramic, rubber, fiber etc.

Currently, in the 3D printing, the layers of the material are deposited through various processes such as melting, extrusion, light polymerized etc. For example, if the layers of the material are deposited using an extrusion process, then an extruder, in the printing head, lays down a first layer by extruding the material. Thereafter, the extruder returns to a starting point (i.e., an initial position) in order to lay down a second layer. Such type of a system in forming the 3D objects takes a lot of time. Therefore, there is a need for a 3D printing system that reduces time taken for building the 3D objects. Also, at times, a 3D object to be built is very small and the extruder returns to the starting point (i.e., the initial position) before the first layer is properly cured. In such a case, the first layer is not able to support weight of the second layer and looses shape. Therefore, there is a need for a 3D printing system that prevents failing of layers.

Chinese Publication Number 104260355 discloses a method for controlling a 3D printer with two printing heads. The two printing heads of the 3D printer have a minimum spacing between them. The reference further discloses that distal end of the two printing heads is placed on a plane so that the two printing heads are capable of printing a co-sectional work piece at a same time. However, such type of 3D printer is not able to reduce time for every type of a structure. Also, in a case, the 3D printer is used for printing small objects, the printing head will have to wait for curing of a layer, before depositing another layer of the material. Therefore, there is a need for a 3D printing system that reduces time taken for building 3D objects.

### SUMMARY OF THE INVENTION

In one aspect of the present disclosure, a three dimensional printing system is provided. The three dimensional printing system includes a cement source adapted to supply a material. A first extruder is adapted to extrude the material to form a first layer, the first extruder being in fluid communication with the cement source, and adapted to receive the material from the cement source. At least one second extruder is adapted to extrude the material to form at least one second layer over the first layer, the at least one second extruder being in fluid communication with the cement source, and adapted to receive the material from the cement source. Each of the first extruder and the at least one second extruder being placed in a series configuration with each other, and the first extruder and the at least one second extruder are adapted to work in collaboration, such that the first extruder and the at least one second extruder move simultaneously and the at least one second layer is formed over the first layer after a delay. The delay is proportional to a rate of motion of the first extruder or the at least one second extruder, a rate of solidification of the material, as-extruded surface tension, and inherent integrity of the material.

Other features and aspects of this disclosure will be apparent from the following description and the accompanying drawings.

### BRIEF DESCRIPTION OF THE DRAWINGS

FIG. 1 is a perspective view of a three dimensional printing system having two extruders, in accordance with the concepts of the present disclosure;

FIG. 2 is a front view of the two extruders of the three dimensional printing system of FIG. 1, in accordance with the concepts of the present disclosure; and

FIG. 3 is a front view showing three extruders of the three dimensional printing system of FIG. 1, in accordance with a second embodiment of the present disclosure.

### DETAILED DESCRIPTION

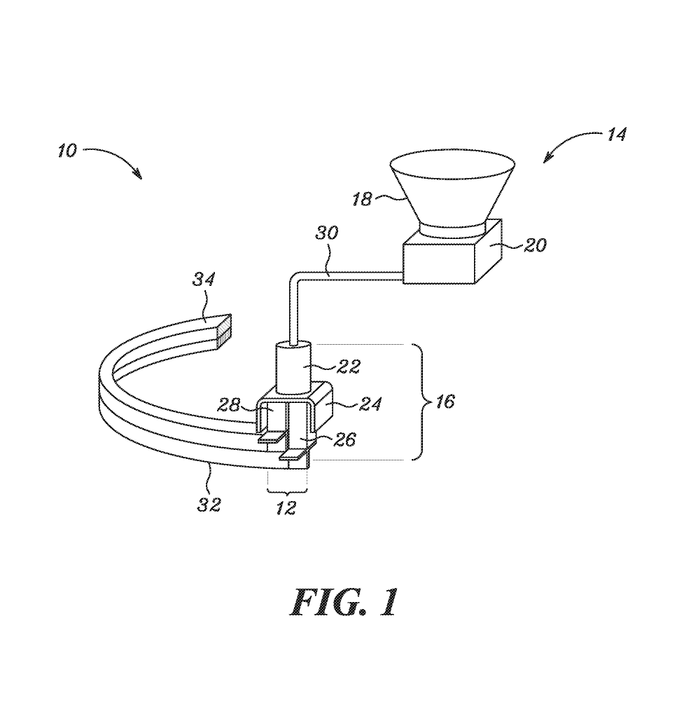

FIG. 1 is a perspective view of a three dimensional printing system 10 having two extruders 12, in accordance with the concepts of the present disclosure. The three dimensional printing system 10 includes a cement source 14, and a printer head 16. As an example, the cement source 14 includes a hopper 18 and a pump 20. The printer head 16 includes an upper portion 22, a frame 24, a first extruder 26, and a second extruder 28. The printer head 16 is placed downstream of the cement source 14. It should be noted that the three dimensional printing system 10 may include more than two extruders, without departing from the scope of disclosure.

The hopper 18 is used to supply ingredients to the pump 20 of the cement source 14, in a powdered or viscous (i.e., wetted) form which is converted into a material utilized for creating 3D models. The cement source 14 includes the hopper 18 and the pump 20, which are adapted to prepare the material by pressurized mixing, unpressurized mixing, heating, extruding, laminating or any other suitable process. The material prepared in the cement source 14 includes, but not limited to, combinations of a liquid component, a cementicious mixture, a ceramic material, a plasticized material, a pumpable, and extrudable rubber-like material etc. It should be noted that the materials mentioned above have been provided only for illustration purposes. Further, the cement source 14 is in fluid communication with the printer head 16, and is adapted to supply the mixture of the material through a conduit 30 to the printer head 16. The printer head 16 having the upper portion 22 through which the mixture of the material flows, and reaches to the frame 24 of the printer head 16. Thereafter, the mixture of the material is passed through the frame 24 of the printer head 16 to the two extruders 12. The two extruders 12, i.e., the first extruder 26 and the second extruder 28 are placed in a series configuration with each other. It will be apparent to one skilled in the art that the material is prepared by mixing multiple ingredients in a predetermined concentration which may vary depending on the desired completed strength, in combination with the processes mentioned above.

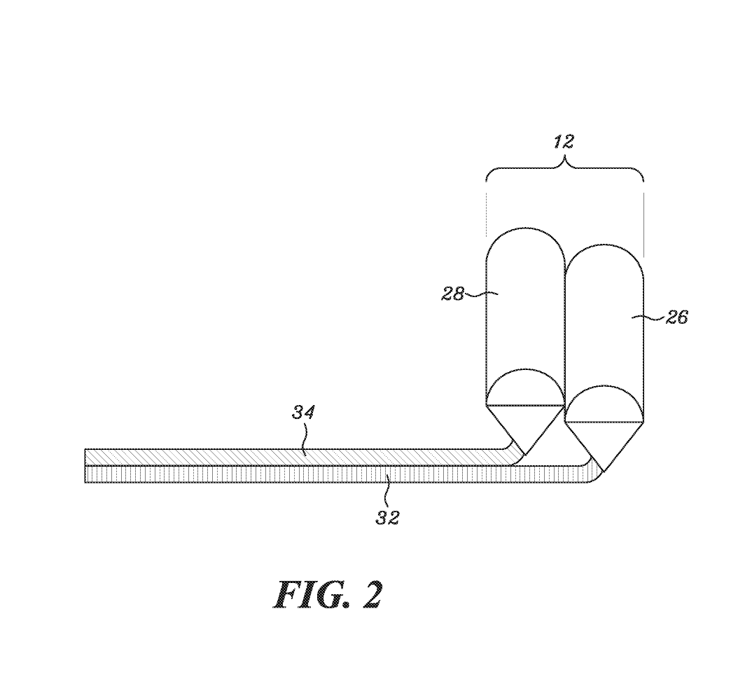

Referring to FIGS. 1 and 2, each of the first extruder 26 and the second extruder 28, are adapted to work in collaboration, such that the first extruder 26 and the second extruder 28 move simultaneously. The first extruder 26 and the second extruder 28, are in fluid communication with the cement source 14, and are adapted to receive the material from the cement source 14. After receiving the material from the cement source 14, the two extruders 12 move simultaneously, and form layers one over the other i.e., the first extruder 26 extrudes the material to form a first layer 32, and the second extruder 28 extrudes the material to form a second layer 34 over the first layer 32. The second layer 34 is formed over the first layer 32 after a delay. The delay is proportional to a rate of motion of the first extruder 26 or the second extruder 28, a rate of solidification of the material, as-extruded surface tension, and inherent integrity of the material. For example, if the rate of solidification or as-extruded surface tension, and inherent integrity of the layers is 1-3 seconds, then the second layer 34 is formed over the first layer 32 after 1-3 seconds.

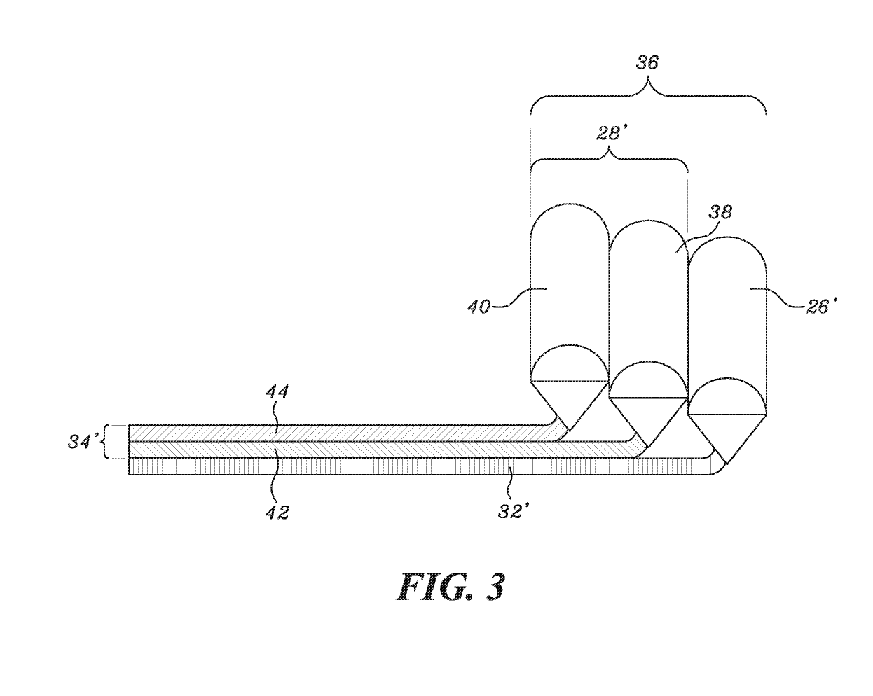

FIG. 3 is a front view showing three extruders 36 of the three dimensional printing system 10 of FIG. 1, in accordance with a second embodiment of the present disclosure. The three extruders 36 include a first extruder 26′ and at least one second extruder 28′. The at least one second extruder 28′ includes a third extruder 38 and a fourth extruder 40. The three extruders 36 (i.e., the first extruder 26′ and the at least one second extruder 28′) are placed in a series configuration with each other, and are adapted to work in collaboration, such that the three extruders 36 (i.e., the first extruder 26′ and the at least one second extruder 28′) move simultaneously. As discussed above, the three extruders 36 (i.e., the first extruder 26′ and the at least one second extruder 28′) are in fluid communication with the cement source 14 (shown in FIG. 1). Each of the first extruder 26′ and the at least one second extruder 28′, is adapted to receive the material from the cement source 14 (shown in FIG. 1).

After receiving the material from the cement source 14, the three extruders 36 move simultaneously, and form layers one over the other i.e., the first extruder 26′ extrudes the material to form a first layer 32′, and the third extruder 38 extrudes the material to form a third layer 42 over the first layer 32′ after a delay. Similarly, the fourth extruder 40 of the at least one second extruder 28′ extrudes the material to form a fourth layer 44 over the third layer 42 after the delay. As discussed above, the delay is proportional to a rate of motion of the first extruder 26′ or the at least one second extruder 28′ (i.e., the third extruder 38 and the fourth extruder 40), a rate of solidification of the material, as-extruded surface tension, and inherent integrity of the material.

### INDUSTRIAL APPLICABILITY

The present disclosure provides the three dimensional printing system 10. The three dimensional printing system 10 discloses the cement source 14 which is in fluid communication with the first extruder 26 and the second extruder 28. The first extruder 26 and the second extruder 28 are placed in a series configuration with each other, and are adapted to work in collaboration such that the first extruder 26 and the second extruder 28 move simultaneously. The first extruder 26 extrudes the material to form the first layer 32, and the second extruder 28 extrudes the material to form the second layer 34 over the first layer 32 after the delay. The delay is proportional to a rate of motion of the first extruder 26 or the second extruder 28, a rate of solidification of the material, or as-extruded surface tension, and inherent integrity of the material. Such type of the three dimensional printing system 10 reduces time taken for building 3D objects and decreases the machine hour cost to manufacture an article of interest. Also, the three dimensional printing system 10 ensures proper solidification of the material, and layer-by-layer adhesion, and thereby prevents failing of layers.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A three dimensional printing system comprising:
a cement source adapted to supply a material;
a first extruder adapted to extrude the material to form a first layer, the first extruder being in fluid communication with the cement source, and adapted to receive the material from the cement source; and
at least one second extruder adapted to extrude the material to form at least one second layer over the first layer, the at least one second extruder being in fluid communication with the cement source, and adapted to receive the material from the cement source;
wherein each of the first extruder and the at least one second extruder being placed in a series configuration with each other, and the first extruder and the at least one second extruder are adapted to work in collaboration, such that the first extruder and the at least one second extruder move simultaneously and the at least one second layer is formed over the first layer after a delay, wherein the delay is proportional to a rate of motion of the first extruder or the at least one second extruder, a rate of solidification of the material, as-extruded surface tension, and inherent integrity of the material.
